(19) United States
(12) Patent Application Publication
(10) Pub. No.: US 2006/0003214 A1
(43) Pub. Date: Jan. 5, 2006

(54) Polymer electrolyte membrane for fuel cell and method for preparing the same

(76) Inventors: Hee-Tak Kim, Suwon-si (KR); Hyoung-Juhn Kim, Suwon-si (KR); Ho-Jin Kweon, Suwon-si (KR)

Correspondence Address: CHRISTIE, PARKER & HALE, LLP, PO BOX 7068, PASADENA, CA, 91109-7068, US

(21) Appl. No.: 11/173,070

(22) Filed: Jun. 30, 2005

(30) Foreign Application Priority Data
Jun. 30, 2004 (KR) 10-2004-0050770

(51) Int. Cl. H01M 8/10; C08J 5/22

(52) U.S. Cl. 429/30; 429/33; 521/27

(57) ABSTRACT

A polymer electrolyte membrane for a fuel cell includes a porous membrane forming micropores. Proton-conducting polymers fill the micropores of the porous membrane. In addition, a method for preparing the polymer electrolyte membrane includes: preparing a porous membrane having a plurality of micropores; and filling the micropores with proton-conducting polymer.

### CROSS-REFERENCE TO RELATED APPLICATION

This application claims priority to and the benefit of Korean Patent Application No. 10-2004-0050770 filed on Jun. 30, 2004 in the Korean Intellectual Property Office, the entire content of which is incorporated herein by reference.

### FIELD OF THE INVENTION

The present invention relates to a polymer electrolyte membrane for a fuel cell and to a method for preparing the same, and more specifically relates to a polymer electrolyte membrane with improved mechanical strength and proton conductivity (or permeability), and a method for preparing the same.

### BACKGROUND OF THE INVENTION

A fuel cell is a device for generating electricity directly through an electrochemical redox reaction of oxygen and hydrogen or hydrogen contained in hydrocarbon materials such as methanol, ethanol, or natural gas.

A fuel cell can be classified into a phosphoric acid type, a fused carbonate type, a solid oxide type, a polymer electrolyte type, or an alkaline type, depending upon the kind of electrolyte used. Although each of these different types of fuel cells operates in accordance with the same basic principles, they may differ from one another in the kind of the fuel, the operating temperatures, the catalyst, and the electrolyte used.

Recently, polymer electrolyte membrane fuel cells (PEMFCs) have been developed. They have power characteristics that are superior to conventional fuel cells, as well as lower operating temperatures, and faster start and response characteristics. Because of this, PEMFCs can be applied to a wide range of fields, such as for transportable electric sources for automobiles, distributed power sources for houses and public buildings, and small electric sources for electronic devices.

A PEMFC is essentially composed of a stack, a reformer, a fuel tank, and a fuel pump. The stack forms a body of the PEMFC, and the fuel pump provides fuel stored in the fuel tank to the reformer using power which can be provided by the PEMFC. The reformer reforms the fuel to generate hydrogen gas and supplies the hydrogen gas to the stack. The hydrogen gas is electrochemically reacted with oxygen in the stack to generate electric energy.

Alternatively, a fuel cell may be a direct methanol fuel cell (DMFC) in which liquid methanol fuel is directly introduced to the stack. Unlike a PEMFC, a DMFC does not require a reformer.

In the fuel cell system described above, the stack in the fuel cell system generates electricity and has a layered structure having several unit cells stacked adjacent one another. Each unit cell is composed of a membrane-electrode assembly (MEA) and two separators (or bipolar plates). The MEA has a polymer electrolyte membrane interposed between an anode (referred to also as fuel electrode or oxidation electrode) and a cathode (referred to also as air electrode or reduction electrode). The separators function both as passageways for supplying the fuel and the oxygen required for a reaction to the anode and the cathode, as well as conductors for serially connecting the anode and the cathode in the MEA (or connecting the cathode of the MEA to the anode of a neighboring MEA). The electrochemical oxidation reaction of the fuel occurs at the anode, and the electrochemical reduction reaction of the oxygen occurs at the cathode, thereby producing electricity, heat, and water due to the migration of the electrons generated during the reactions.

As mentioned above, an MEA includes a polymer electrolyte membrane. The polymer electrolyte membrane functions as an electrolyte in the MEA. Polymer electrolyte membranes can be fabricated using fluoride-based electrolyte membranes such as perfluorosulfonic acid ionomer membranes such as Nafion® (DuPont Inc.), Aciplex® and Flemion® (Asahi Glass Co.), and Dow® XUS (Dow Chemical Co.).

However, since the above listed polymer electrolyte membranes have low mechanical strength, their long-term usage produces pin-holes. The pin-holes result in the mixing of fuel and oxidant (oxygen), thereby decreasing the energy conversion rate and deteriorating the output characteristics of the polymer electrolyte membranes. Because of this, thicker electrolyte membranes are sometimes used in order to improve mechanical strength; however, this may also increase the volume of the MEA as well as increase proton resistance and material cost.

### SUMMARY OF THE INVENTION

An embodiment of the present invention provides a polymer electrolyte membrane for a fuel cell having excellent mechanical strength and proton conductivity (or permeability).

Another embodiment of the present invention provides a method for preparing the polymer electrolyte membrane for the fuel cell.

One embodiment of the present invention provides a polymer electrolyte membrane for a fuel cell. The polymer electrolyte membrane includes a porous membrane with micropores, and proton-conducting polymers within the micropores of the porous membrane.

One embodiment of the present invention provides a method for preparing a polymer electrolyte membrane for a fuel cell. This method includes preparing a porous membrane with micropores and filling proton-conducting polymers into the micropores of the porous membrane.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic view illustrating an enlarged cross-section for a polymer electrolyte membrane for a fuel cell according to the present invention.

FIG. 2 is a schematic view illustrating an enlarged cross-section for a porous membrane with micropores.

### DETAILED DESCRIPTION

In the following detailed description, only certain exemplary embodiments of the present invention are shown and described, simply by way of illustration. As those skilled in the art would realize, the described exemplary embodiments may be modified in various different ways, all without departing from the spirit or scope of the present invention. Accordingly, the drawings and description are to be regarded as illustrative in nature, and not restrictive.

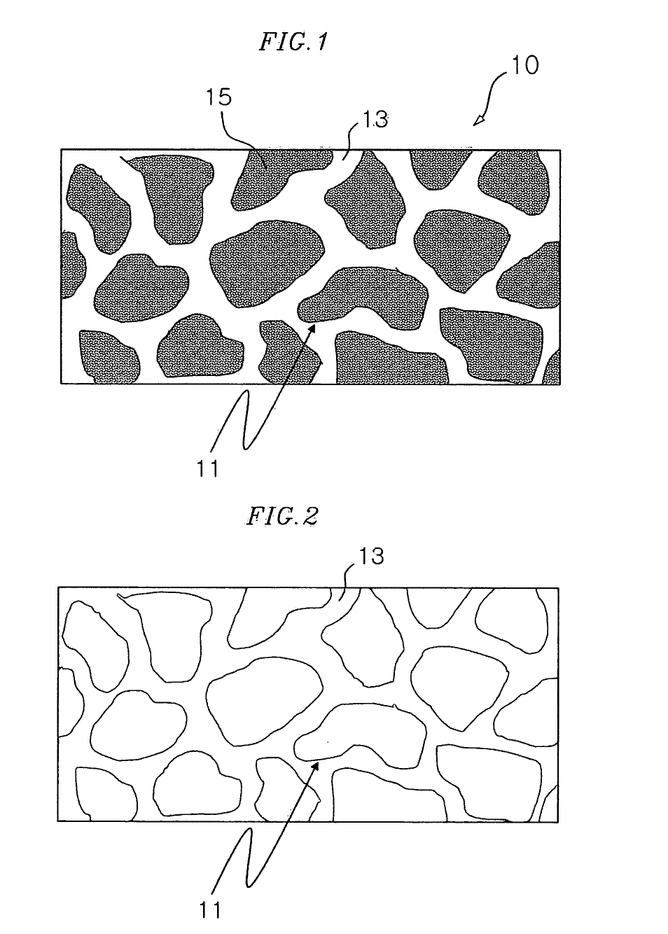

FIG. 1 is a schematic view illustrating an enlarged cross-section for a polymer electrolyte membrane 10 for a fuel cell according to the present invention. As shown in FIG. 1, the polymer electrolyte membrane 10 includes a porous membrane 13 with micropores 11. Proton-conducting polymers 15 are shown to be within the micropores 11 of the porous membrane.

A porous membrane of the present invention (e.g., the porous membrane 13 of FIG. 1) has excellent mechanical strength, thereby improving the dimensional stability of a polymer electrolyte membrane (e.g., the polymer electrolyte membrane 10 of FIG. 1) containing the porous membrane. In addition, the porous membrane of the present invention has a framework for preventing volume expansion due to water. In one embodiment of the present invention, a mechanical strength of the porous membrane has a tensile modulus (or Young's modulus) in a range from about 50 MPa to 300 MPa, more preferably from about 81 MPa to 230 MPa at dry state, as shown in Table 1 below. “dry state” in the present invention means that the porous membrane has no water. When the tensile modulus of the porous membrane is less than 50 MPa, the membrane is easily distorted during filling of a proton-conducting polymer into the micropores of the porous membrane or during fabrication of a membrane-electrode assembly containing the porous membrane. Alternatively, when the tensile modulus of the porous membrane exceeds 300 MPa, there are difficulties in maintaining the porosity of the porous membrane. Furthermore, in one embodiment of the invention, micropores (e.g., the micropores 11 of FIG. 1) formed in the porous membrane of the present invention are three-dimensionally connected open micropores. Such a pore structure is achieved where the porous membrane is a thin film or a non-woven fabric having the three-dimensionally connected open micropores.

Also, the porous membrane has a thickness in a range from 20 to 40 μm, preferably in a range from 25 to 40 μm. When the thickness of the porous membrane is less than 20 μm, it may not give a sufficiently improved mechanical strength. Alternatively, when the thickness of the porous membrane exceeds 40 μm, the resistance of the polymer electrolyte membrane is increased.

In one embodiment of the present invention, the porous membrane has a porosity in a range from 20% to 70% and preferably from 30% to 60% by volume relative to its total volume. When the porous membrane has a porosity that is less than 20%, it may not include a sufficient amount of proton-conducting polymers within its micropores. Alternatively, when the porous membrane has a porosity of more than 70%, it may not give a sufficiently improved mechanical strength.

Further, in one embodiment of the invention, the micropores formed in the porous membrane of the present invention have an average diameter within a range from 3 to 10 μm, and more preferably within a range from 3 to 5 μm. When the micropores have an average diameter of less than 3 μm, they do not provide sufficient proton conductivity for the polymer electrolyte membrane. Alternatively, when the micropores have an average diameter of more than 10 μm, pore uniformity is deteriorated and thus the micropores do not improve the mechanical strength of the porous membrane.

The porous membrane of the present invention may be a polymer resin having excellent mechanical strength and low-volume change because of its low hygroscopicity. In some embodiments, one or more polymers and their co-polymers may be used. The polymers may be selected from the group consisting of polyolefin fibers, polyester fibers, polysulfone fibers, polyimide fibers, polyetherimide fibers, polyamide fibers, rayon fibers, glass fibers, and combinations thereof. In an embodiment, rayon fibers and glass fibers are used because of their excellent stability at high temperature.

In one embodiment, the porous membrane of the present invention includes proton-conducting polymers (e.g., the proton-conducting polymers 15 of FIG. 1) within the micropores of the porous membrane. The proton-conducting polymers function as the electrolyte for the polymer electrolyte membrane containing the proton-conducting polymers. In one embodiment, the proton-conducting polymers are three-dimensionally connected with each other to form a network of ion transport pathways within the micropores.

In one embodiment, the proton-conducting polymers have a volume in a range from 20% to 70% of the total volume of the polymer electrolyte membrane. In some embodiments, the proton-conducting polymers may have a volume in a range from 30% to 60% relative to the total volume of the polymer electrolyte membrane. When the composition of the proton-conducting polymers is less than 20% by volume, the composition exhibits lower proton conductivity than is desired. Alternatively, when the composition of the proton-conducting polymers is more than 70% by volume, the composition may result in volume expansion due to humidity as well as deterioration of mechanical strength.

In one embodiment, a proton-conducting polymer may be a polymer typically used as a material for an electrolyte membrane for a fuel cell. Exemplary materials for the proton-conducting polymer include perfluoro-based polymers, benzimidazole-based polymers, polyimide-based polymers, polyetherimide-based polymers, polyphenylene sulfide-based polymers, polysulfone-based polymers, polyethersulfone-based polymers, polyetherketone-based polymers, polyether-etherketone-based polymers, polyphenylquinoxaline-based polymers, and combinations thereof. In some embodiments, the proton-conducting polymer includes poly(perfluorosulfonic acid), poly(perfluorocarboxylic acid), co-polymers of tetrafluoroethylene and fluorovinylether containing sulfonic acid groups, defluorinated polyetherketone sulfides, aryl ketones, poly(2,2′-(m-phenylene)-5,5′-bibenzimidazole), poly(2,5-benzimidazole), and combinations thereof. However, in the present invention, a proton-conducting polymer included in a polymer electrolyte membrane for a fuel cell is not limited to the above discussed examples.

According to the present invention, a method for preparing a polymer electrolyte membrane for a fuel cell includes: a) preparing a porous membrane with micropores; and b) filling proton-conducting polymers into the micropores of the porous membrane.

A mechanical strength of the porous membrane in step a) has a tensile modulus in a range from 50 MPa to 300 MPa, preferably in a range from 81 MPa to 230 MPa at dry state, as shown in Table 1 below. In one embodiment, the porous membrane includes three-dimensionally connected open micropores, and in some preferred embodiments, includes a thin film or a non-woven fabric containing the three-dimensionally connected open micropores.

Also, the porous membrane has a thickness in a range from 20 to 40 μm, preferably in a range from 25 to 40 μm.

In one embodiment of the present invention, the thin film is prepared by such techniques as solvent evaporation, extraction, phase separation, etc. In one embodiment, the non-woven fabric is prepared by a method known to those skilled in the art. However, methods and/or techniques for preparing the thin film or the non-woven fabric of the present invention are not thereby limited.

For example, a porous membrane can be prepared by a method in which a mixed slurry of a fiber, a binder, and a solvent is coated and then the solvent is evaporated; a method in which a polymer solution with a polymer homogeneously dissolved in a solvent is coated and then the solvent is fast volatilized to form pores; or a method in which a polymer solution with a polymer homogeneously dissolved in a solvent is soaked in another solvent with lower affinity for the polymer to induce phase separation.

In addition, a porous membrane can be prepared by an extraction method, where a film is prepared by mixing a polymer, a solvent with low volatility, and either an organic compound or an inorganic compound with molecular weight of not more than 10,000, followed by soaking the mixture into another solvent capable of selectively dissolving the solvent with low volatility, the organic compound, or the inorganic compound. Further, after preparing the film made of a foaming agent and the polymer, the porous membrane can be prepared by foaming the film using heat or photo-radiation. FIG. 2 is a schematic view illustrating an enlarged cross-section of a porous membrane 13 with micropores 11.

In one embodiment, a porous membrane (e.g., the porous membrane 13 of FIG. 2) has a porosity in a range from 20% to 70%, and preferably from 30% to 60% by volume relative to its total volume. When the porous membrane has a porosity that is less than 20%, it cannot include a sufficient amount of proton-conducting polymers within its micropores. Alternatively, when the porous membrane has a porosity of more than 70%, it does not give a sufficiently improved mechanical strength.

Further, in one embodiment, the micropores (e.g., the micropores 11′ of FIG. 2) formed in the porous membrane have an average diameter in a range from 3 to 10 μm, and preferably from 3 to 5 μm. When the micropores have an average diameter of less than 3 μm, they do not provide sufficient proton conductivity to the polymer electrolyte membrane. Alternatively, when the micropores have an average diameter of more than 10 μm, pore uniformity is deteriorated and thus the micropores do not improve the mechanical strength of the porous membrane.

In some embodiments, the porous membrane is a polymer resin having excellent mechanical strength and low volume change because of its low hygroscopicity. One or more polymers and their co-polymers are selected from the group consisting of polyolefin fibers, polyester fibers, polysulfone fibers, polyimide fibers, polyetherimide fibers, polyamide fibers, rayon fibers, and glass fibers. In one embodiment, the polymers are selected from rayon fibers and glass fibers.

In one embodiment, the porous membrane includes proton-conducting polymers within its micropores. The proton-conducting polymers function as the electrolyte for a polymer electrolyte membrane. The proton-conducting polymers are three-dimensionally connected with each other to form ion transport pathways within the micropores. As such, a method for preparing a polymer electrolyte membrane for a fuel includes filling proton-conducting polymers into micropores of a porous membrane, which function as the electrolyte for the polymer electrolyte membrane. Some embodiments include filling proton-conducting polymers by using an aqueous solution or organic solution having a concentration in a range from 2% to 50% by weight, more preferably 5% to 20% by weight, of proton-conducting polymers within micropores of a porous membrane to form polymer electrolyte membrane. When the concentration of proton-conducting polymers is less than 2% by weight, it is difficult to fill all the voids of the micropores. Alternatively, when the concentration is more than 50% by weight, the viscosity of the solution is too high to properly fill the proton-conducting polymers into the micropores. Solvents for the organic solution include alcohol-based solvents such as methanol, ethanol, propanol, isopropanol, or butanol; amide-based solvents such as dimethylacetamide and dimethylformamide; sulfoxide-based solvents such as dimethylsulfoxide; ester-based solvents; and the like. Proton-conducting polymers can be filled into micropores using a method selected from the group consisting of dipping, pressure reduced dipping, pressure applied dipping, spraying, doctor-blading, silk-screening, transferring, and combinations thereof. Preferably, a pressure reduced dipping process where the porous membrane is dipped into a proton-conducting polymer solution after the micropores of the porous membrane are vacuumized, or a pressure applied dipping process where the porous membrane is dipped into a proton-conducting polymer solution under high pressure, can be used. In one embodiment, the proton-conducting polymers are three-dimensionally connected to each other within the micropores to form ion transport pathways.

In one embodiment, the proton-conducting polymers are filled into the micropores so that the proton-conducting polymers have a volume in a range from 20% to 70% relative to the total volume of the polymer electrolyte membrane. In some embodiments, the proton-conducting polymers may have from 30% to 60% by volume relative to the total volume of the polymer electrolyte membrane. A composition of less than 20% results in low proton-conductivity, and a composition of more than 70% may lead to a volume expansion due to humidity.

In one embodiment, the proton-conducting polymers are used as a material for an electrolyte for a fuel cell. Exemplary materials for the proton-conducting polymers include perfluoro-based polymers, benzimidazole-based polymers, polyimide-based polymers, polyetherimide-based polymers, polyphenylene sulfide-based polymers, polysulfone-based polymers, polyethersulfone-based polymers, polyetherketone-based polymers, polyether-etherketone-based polymers, polyphenylquinoxaline-based polymers, and combinations thereof. In one embodiment, the proton-conducting polymers include but are not limited to poly(perfluorosulfonic acid), poly(perfluorocarboxylic acid), co-polymers of tetrafluoroethylene and fluorovinylether containing sulfonic acid groups, defluorinated polyetherketone sulfides, aryl ketones, poly(2,2′-(m-phenylene)-5,5′-bibenzimidazole), poly(2,5-benzimidazole), and combinations thereof. In the present invention, a proton-conducting polymer included in a polymer electrolyte membrane for a fuel cell is not limited to the above discussed exemplary polymers.

In one embodiment, an additional roll-pressing step is included to more consistently control the thickness of a polymer electrolyte membrane.

The following examples further illustrate the present invention in more detail, but the present invention is not limited by these examples.

### EXAMPLE 1

A non-woven rayon fabric having a thickness of 25 μm, a porosity of 60% by volume, and open micropores with an average diameter of 5 μm was used as a porous membrane. The non-woven rayon fabric was impregnated with 5% by weight of poly(perfluorosulfonic acid) (Nafion®, DuPont Inc.) and then taken out to be dried. The micropores were filled with poly(perfluorosulfonic acid) used as the proton-conducting polymers for the porous membrane. The filling procedure was repeated several times to uniformly fill the poly(perfluorosulfonic acid) into the micropores. Following the filling procedure, a roll-pressing treatment was carried out to prepare a polymer electrolyte membrane having a uniform thickness.

### EXAMPLE 2

A polymer electrolyte membrane for a fuel cell was prepared by substantially the same method as in Example 1, except that a polyethylene film having the same thickness, porosity and average diameter of open micropores I instead of the non-woven rayon fabric was used as the porous membrane.

### EXAMPLE 3

A polymer electrolyte membrane for a fuel cell was prepared by substantially the same method as in Example 1, except that a poly(ethyleneglycol terephtalate) film having the same thickness, porosity and average diameter of open micropores instead of the non-woven rayon fabric was used as the porous membrane.

### EXAMPLE 4

A polymer electrolyte membrane for a fuel cell was prepared by substantially the same method as in Example 1, except that a polysulfone film having the same thickness, porosity and average diameter of open micropores instead of the non-woven rayon fabric was used as the porous membrane.

### EXAMPLE 5

A polymer electrolyte membrane for a fuel cell was prepared by substantially the same method as in Example 1, except that a polyimide film (Kynar®, Dupont Inc.) having the same thickness, porosity and average diameter of open micropores instead of the non-woven rayon fabric was used as the porous membrane.

### EXAMPLE 6

A polymer electrolyte membrane for a fuel cell was prepared by substantially the same method as in Example 1, except that a non-woven rayon fabric having a thickness of 25 μm, a porosity of 60% by volume, and open micropores with an average diameter of 3 μm instead of the non-woven rayon fabric was used as the porous membrane.

### EXAMPLE 7

A polymer electrolyte membrane for a fuel cell was prepared by substantially the same method as in Example 1, except that a non-woven rayon fabric having a thickness of 25 μm, a porosity of 60% by volume, and open micropores with an average diameter of 10 μm instead of the non-woven rayon fabric was used as the porous membrane.

### EXAMPLE 8

A polymer electrolyte membrane for a fuel cell was prepared by substantially the same method as in Example 1, except that a polyether-ethersulfonic acid film having a thickness of 51 μm, a porosity of 60% by volume, and open micropores with an average diameter of 5 μm instead of the non-woven rayon fabric was used as the porous membrane.

### EXAMPLE 9

A polymer electrolyte membrane for a fuel cell was prepared by substantially the same method as in Example 1, except that a polytetrafluoroethylene film having a thickness of 51 μm, a porosity of 60% by volume, and open micropores with an average diameter of 5 μm instead of the non-woven rayon fabric was used as the porous membrane.

### EXAMPLE 10

A polymer electrolyte membrane for a fuel cell was prepared by substantially the same method as in Example 1, except that a polytetrafluoroethylene film having a thickness of 25 μm, a porosity of 60% by volume, and open micropores with an average diameter of 5 μm instead of the non-woven rayon fabric was used as the porous membrane.

### EXAMPLE 11

A polymer electrolyte membrane for a fuel cell was prepared by substantially the same method as in Example 1, except that a polyimide film (Kynar®, Dupont Inc.) having a thickness of 50 μm, a porosity of 60% by volume, and open micropores with an average diameter of 5 μm instead of the non-woven rayon fabric was used as the porous membrane.

### EXAMPLE 12

A polymer electrolyte membrane for a fuel cell was prepared by substantially the same method as in Example 1, except that a non-woven rayon fabric having a thickness of 25 μm, a porosity of 60% by volume, and open micropores with an average diameter of 2 μm instead of the non-woven rayon fabric was used as the porous membrane.

### EXAMPLE 13

A polymer electrolyte membrane for a fuel cell was prepared by substantially the same method as in Example 1, except that a non-woven rayon fabric having a thickness of 25 μm, a porosity of 20% by volume, and open micropores with an average diameter of 5 μm instead of the non-woven rayon fabric was used as the porous membrane.

### EXAMPLE 14

A polymer electrolyte membrane for a fuel cell was prepared by substantially the same method as in Example 1, except that a non-woven rayon fabric having a thickness of 25 μm, a porosity of 70% by volume, and open micropores with an average diameter of 5 μm instead of the non-woven rayon fabric was used as the porous membrane.

### EXAMPLE 15

A polymer electrolyte membrane for a fuel cell was prepared by substantially the same method as in Example 1, except that a non-woven rayon fabric having a thickness of 20 μm, a porosity of 60% by volume, and open micropores with an average diameter of 5 μm instead of the non-woven rayon fabric was used as the porous membrane.

### EXAMPLE 16

A polymer electrolyte membrane for a fuel cell was prepared by substantially the same method as in Example 1, except that a non-woven rayon fabric having a thickness of 40 μm, a porosity of 60% by volume, and open micropores with an average diameter of 5 μm instead of the non-woven rayon fabric was used as the porous membrane.

### EXAMPLE 17

A polymer electrolyte membrane for a fuel cell was prepared by substantially the same method as in Example 1, except that poly(perfluorocarboxylic acid) instead of the poly(perfluorosulfonic acid) was used as the proton-conducting polymers.

### EXAMPLE 18

A polymer electrolyte membrane for a fuel cell was prepared by substantially the same method as in Example 1, except that poly(2,2′-(m-phenylene)-5,5′-bibenzimidazole) instead of the poly(perfluorosulfonic acid) was used as the proton-conducting polymers.

### EXAMPLE 19

A polymer electrolyte membrane for a fuel cell was prepared by substantially the same method as in Example 1, except that a polyethylene film and poly(2,5-benzimidazole) instead of the non-woven rayon fabric and the poly(perfluorosulfonic acid) were used.

### COMPARATIVE EXAMPLE 1

A polymer electrolyte membrane for a fuel cell was prepared by substantially the same method as in Example 1, except that a poly(perfluorosulfonic acid) film (Nafion®) 112, DuPont Inc.) having a thickness of 51 μm, a porosity of 60% by volume, and open micropores with an average diameter of 5 μm instead of the non-woven rayon fabric was used as the porous membrane.

The mechanical strengths (Tensile modulus) of the porous membranes used in the Examples and the Comparative Examples, in dry and wet states, are shown in Table 1. “dry state” means that the porous membrane has no water, and “wet state” means that the porous membrane was 100% hydrated after impregnating it with water. Table 1

TABLE 1

| | | | | Average Diameter | | |
|---|---|---|---|---|---|---|
| | Porous | Thickness | Porosity | of Open | Tensile Modulus (Mpa) | |
| | Membrane | (μm) | (% by volume) | Micropores (μm) | Dry | Wet |
| Example 1 | rayon | 25 | 60 | 5 | 203 | 185 |
| Example 2 | polyethylene | 25 | 60 | 5 | 81 | 81 |
| Example 3 | poly(ethylene- | 25 | 60 | 5 | 92 | 90 |
| | glycolterephtalate) | | | | | |
| Example 4 | polysulfone | 25 | 60 | 5 | 125 | 125 |
| Example 5 | polyimide | 25 | 60 | 5 | 230 | 225 |
| Example 6 | rayon | 25 | 60 | 3 | 280 | 253 |
| Example 7 | rayon | 25 | 60 | 10 | 179 | 153 |
| Example 8 | polyetherether- | 51 | 60 | 5 | 53.5 | 51.7 |
| | sulfonic acid | | | | | |
| Example 9 | polytetrafluoro- | 51 | 60 | 5 | 62 | 58 |
| | ethylene | | | | | |
| Example 10 | polytetrafluoro- | 25 | 60 | 5 | 37 | 25 |
| | ethylene | | | | | |
| Example 11 | polyimide | 50 | 60 | 5 | 330 | 302 |
| Example 12 | rayon | 25 | 60 | 2 | 288 | 251 |
| Example 13 | rayon | 25 | 20 | 5 | 298 | 291 |
| Example 14 | rayon | 25 | 70 | 5 | 275 | 259 |
| Example 15 | rayon | 20 | 60 | 5 | 263 | 240 |
| Example 16 | rayon | 40 | 60 | 5 | 286 | 259 |
| Comparative | poly(perfluoro- | 51 | 60 | 5 | 21.4 | 5.7 |
| Example 1 | sulfonic acid) | | | | | |

The resistances of the polymer electrolyte membranes prepared according to the Examples and the Comparative Examples were also measured using a two-electrode method under humidified conditions at room temperature. In addition, the mechanical strengths (tensile modulus) of the polymer electrolyte membranes according to the Examples and the Comparative Examples were also measured using a tester (Instron). The resulting measurements are shown in Table 2.

The mechanical strengths (tensile modulus) and resistances of the polymer electrolyte membranes of the Examples and the Comparative Example 1 are shown in Table 2 as relative values using the values of the polymer electrolyte membrane of Comparative Example 1 as references.

TABLE 2

| | | Relative | |
|---|---|---|---|
| | | Tensile | Relative |
| | Porous Membrane | Modulus | Resistance |
| Example 1 | rayon | 42 | 0.61 |
| Example 2 | polyolefin | 18 | 0.75 |
| Example 3 | polyester | 30 | 0.78 |
| Example 4 | polysulfone | 38 | 0.84 |
| Example 5 | polyimide | 52 | 0.52 |
| Example 6 | rayon | 58 | 0.71 |
| Example 7 | rayon | 40 | 0.54 |
| Example 8 | polyetherethersulfonic acid | 2.5 | 1.1 |
| Example 9 | polytetrafluoroethylene | 2.8 | 1.3 |
| Example 10 | polytetrafluoroethylene | 1.4 | 0.95 |
| Example 11 | polyimide | 66 | 1.2 |
| Example 12 | rayon | 58 | 1.1 |
| Example 13 | rayon | 63 | 0.75 |
| Example 14 | rayon | 50 | 0.69 |
| Example 15 | rayon | 48 | 0.71 |
| Example 16 | rayon | 45 | 0.81 |
| Comparative | poly(perfluorosulfonic acid) | 1 | 1 |
| Example 1 | | | |

The relative resistance of the polymer electrolyte membrane of Example 1 is shown to be 0.61 when the resistance of the polymer electrolyte membrane of Comparative Example 1 is set to be 1, and the relative strength of the polymer electrolyte membrane of Example 1 is shown to be 42 when the mechanical strength of the polymer electrolyte membrane in Comparative Example 1 is set to be 1. As such, the polymer electrolyte membrane prepared according to Example 1 of the present invention has a decreased resistance of 61% and a mechanical strength that is improved by 42 times as compared to the electrolyte membrane prepared according to Comparative Example 1.

Generally, the higher the conductivity and the thinner the thickness of the electrolyte membrane, the higher its resistance. The reason that the resistances of the electrolyte membranes in Examples 1 to 7 and Examples 13 to 16 are lower than that of Comparative Example 1, is because of the use of the porous membranes having a high mechanical strengths as in the form of thin film. As such that, a decrease of the thickness of the porous membrane leads to a decrease of the thickness and resistance in the electrolyte membrane. Also, the electrolyte membranes in Examples 8, 9, 11 and 12 having high mechanical strengths but high thicknesses, show high resistances.

The lower the resistance of the electrolyte membrane, the higher its proton conductivity. Thus, to evaluate the proton conductivity of the polymer electrolyte membrane of Example 1 and the polymer electrolyte membrane of Comparative Example 1, the resistances per cm² were measured for the polymer electrolyte membrane of Example 1 and the polymer electrolyte membrane of Comparative Example 1. In particular, 1 cm² stainless steel electrodes were attached on both sides of the polymer electrolyte membrane of Example 1 and the polymer electrolyte membrane of Comparative Example 1. AC impedances for the polymer electrolyte membrane of Example 1 and the polymer electrolyte membrane of Comparative Example 1 were then measured at room temperature. The resistances of the membranes per cm² were then determined and are shown in Table 3.

TABLE 3

| | Resistance(Ω/cm²) |
|---|---|
| Example 1 | 0.13 |
| Comparative Example 1 | 0.21 |

As shown in Table 3, the electrolyte membrane of Example 1 shows a lower resistance than that of Comparative Example 1, so it can be seen that the electrolyte membrane of Example 1 has higher or superior proton conductivity than that of Comparative Example 1.

In view of the foregoing, a polymer electrolyte membrane of the present invention has the advantages of high-proton conductivity and excellent mechanical strength.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A polymer electrolyte membrane for a fuel cell comprising:
a porous membrane having a plurality of micropores; and
a proton-conducting polymer within the micropores of the porous membrane,
wherein the porous membrane has a tensile modulus from 50 MPa to 300 MPa at dry state.

2. The polymer electrolyte membrane according to claim 1, wherein the porous membrane has the tensile modulus in a range from 81 MPa to 230 MPa at dry state.

3. The polymer electrolyte membrane according to claim 1, wherein the porous membrane has a thickness in a range from 20 to 40 μm.

4. The polymer electrolyte membrane according to claim 1, wherein the micropores of the porous membrane are open micropores.

5. The polymer electrolyte membrane according to claim 1, wherein the porous membrane has a porosity in a range from 20% to 70% by volume relative to a total volume of the porous membrane.

6. The polymer electrolyte membrane according to claim 1, wherein the micropores of the porous membrane have an average diameter and wherein the average diameter is in a range from 3 to 10 μm.

7. The polymer electrolyte membrane according to claim 1, wherein the porous membrane comprises a material selected from the group consisting of polyolefin, polyester, polysulfone, polyimide, polyetherimide, polyamide, rayon, glass fiber, and combinations thereof.

8. The polymer electrolyte membrane according to claim 1, wherein the porous membrane comprises a material selected from the group consisting of rayon and glass fiber.

9. The polymer electrolyte membrane according to claim 1, wherein the proton-conducting polymer comprises from 20% to 70% of a total volume of the polymer electrolyte membrane.

10. The polymer electrolyte membrane according to claim 1, wherein the proton-conducting polymer comprises a material selected from the group consisting of perfluoro-based polymers, benzimidazole-based polymers, polyimide-based polymers, polyetherimide-based polymers, polyphenylene sulfide-based polymers, polysulfone-based polymers, polyethersulfone-based polymers, polyetherketone-based polymers, polyether-etherketone-based polymers, polyphenylquinoxaline-based polymers, and combinations thereof.

11. The polymer electrolyte membrane according to claim 1, wherein the proton-conducting polymer comprises a material selected from the group consisting of poly(perfluorosulfonic acid), poly(perfluorocarboxylic acid), co-polymers of tetrafluoroethylene and fluorovinylether containing sulfonic acid groups, defluorinated polyetherketone sulfides, aryl ketones, poly(2,2′-(m-phenylene)-5,5′-bibenzimidazole), poly(2,5-benzimidazole), and combinations thereof.

12. The polymer electrolyte membrane according to claim 1, wherein the proton-conducting polymer comprises a three-dimensionally connected network within the porous membrane.

13. A method for preparing a polymer electrolyte membrane for a fuel cell, comprising:
preparing a porous membrane having a plurality of micropores; and
filling the micropores of the porous membrane with a proton-conducting polymer,
wherein the porous membrane has a tensile modulus from 50 MPa to 300 MPa at dry state,
wherein the porous membrane has a porosity of from 20% to 70% by volume relative to a total volume of the porous membrane,
wherein the micropores of the porous membrane have an average diameter, and
wherein the average diameter is in a range from 3 to 10 μm.

14. The method according to claim 13, wherein the porous membrane has a thickness in a range from 20 to 40 μm.

15. The method according to claim 13, wherein the micropores of the porous membrane are open micropores.

16. The method according to claim 13, wherein the porous membrane comprises a material selected from the group consisting of polyolefin, polyester, polysulfone, polyimide, polyetherimide, polyamide, rayon, glass fiber, and combinations thereof.

17. The method according to claim 13, wherein the porous membrane comprises a material selected from the group consisting of rayon and glass fiber.

18. The method according to claim 13, wherein the filling of the micropores is performed using an aqueous solution having 2% to 50% by weight of the proton-conducting polymers.

19. The method according to claim 13, wherein the filling of the micropores is performed using a method selected from the group consisting of dipping, pressure reduced dipping, pressure applied dipping, spraying, doctor-blading, silk-screening, transferring, and combinations thereof.

20. The method according to claim 13, wherein the proton-conducting polymers comprise from 20% to 70% of a total volume of the polymer electrolyte membrane.

21. The method according to claim 13, wherein the proton-conducting polymer comprises a material selected from the group consisting of perfluoro-based polymers, benzimidazole-based polymers, polyimide-based polymers, polyetherimide-based polymers, polyphenylene sulfide-based polymers, polysulfone-based polymers, polyethersulfone-based polymers, polyetherketone-based polymers, polyether-etherketone-based polymers, polyphenylquinoxaline-based polymers, and combinations thereof.

22. The method according to claim 13, wherein the proton-conducting polymer comprises a material selected from the group consisting of poly(perfluorosulfonic acid), poly(perfluorocarboxylic acid), co-polymers of tetrafluoroethylene and fluorovinylether containing sulfonic acid groups, defluorinated polyetherketone sulfides, aryl ketones, poly(2,2′-(m-phenylene)-5,5′-bibenzimidazole), poly(2,5-benzimidazole), and combinations thereof.

23. A polymer electrolyte membrane for a fuel cell comprising:
a porous membrane having a plurality of micropores; and
a proton-conducting polymer within the micropores of the porous membrane,
wherein the micropores of the porous membrane have an average diameter and wherein the average diameter is in range from 3 to 10 μm.
